(19) United States
(12) Patent Application Publication
(10) Pub. No.: US 2002/0177410 A1
(43) Pub. Date: Nov. 28, 2002

(54) Method of selecting one of at least two terminals

(75) Inventors: Siegfried Klein, Stuttgart (DE); Hajo Bakker, Eberdingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/145,794

(22) Filed: May 16, 2002

(30) Foreign Application Priority Data
May 23, 2001 (DE) 101 25 284.6

(51) Int. Cl. H04Q 7/20

(52) U.S. Cl. 455/41; 455/512; 455/435

(57) ABSTRACT

By automatic, direct point-to-point communication (N2) according to the invention, e.g. by means of Bluetooth, without involving a central server two terminals (T1, T2) establish which of the terminals (T1, T2) should preferably communicate with a transmission network (N1) and register only one of the two terminals (T1, T2) in the transmission network (N1). The terminals (T1, T2) are mutually identified as terminals belonging to a pool of terminals of a subscriber and, as well as the list of terminals of the pool, also have stored, for example, an order of precedence. The order of precedence is similar to an allocation of priorities. If two terminals (T1, T2) are located in a Bluetooth network (N2) they are mutually identified. If one terminal (T2) establishes that the priority assigned to the other terminal is lower than its own it logs on in a transmission network (N1) assigned to it by registering or remains registered in so far as it already was registered. If a terminal (T1) establishes that the priority assigned to the other terminal (T2) is higher than its own it logs off in a transmission network (N1) assigned to it in so far as it was logged on by registering.

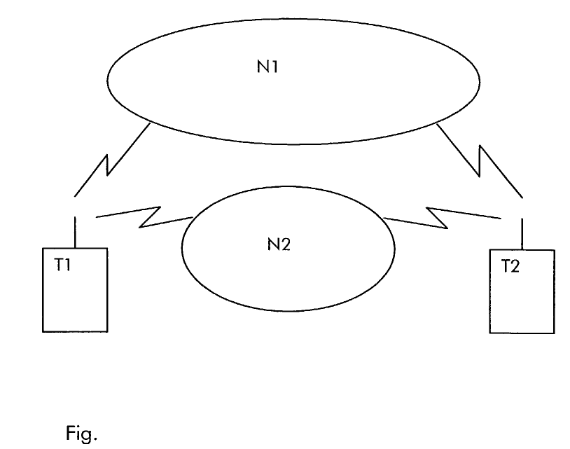

### TECHNICAL FIELD

The invention relates to a method of selecting one of at least two terminals. The invention is based on a priority application 101 25 284.6 which is hereby incorporated by reference.

### BACKGROUND OF THE INVENTION

A method of selecting one of at least two telecommunications terminals is known from WO95/34985. A server of a service provider manages various, registered terminals of a subscriber and automatically forwards calls to the terminal located nearest to the subscriber. Identification of the nearest terminal is done by a subscriber identification card which the subscriber must always carry and which can be remotely interrogated within a circumscribed area. If a terminal identifies the subscriber identification card it reports this to the central server, which then forwards calls to this terminal. A disadvantageous effect is that a central server is needed and the subscriber identification card must always be carried.

### SUMMARY OF THE INVENTION

The object of the invention is to cite a technically less complicated method of selecting one of at least two terminals.

This object is achieved by a method of selecting one of at least two terminals (T1, T2), wherein each terminal (T1, T2) has an interface to a first (N1) and a second (N2) transmission network and the second transmission network (N2) enables a direct connection between two terminals (T1, T2) within a circumscribed area, characterised in that two terminals (T1, T2) identify one another via the second transmission network (N2) and decide independently whether to register in the first transmission network (N1) and initiate registration or logging off, a system Transmission system containing a first transmission network (N1), a second transmission network (N2), a first terminal (T1) with an interface to the first (N1) and an interface to the second (N2) transmission network and a second terminal (T2) with an interface to the first (N1) and an interface to the second (N2) transmission network, characterised in that the two terminals (T1, T2) are suitable for identifying one another via the second transmission network (N2) and for deciding independently in each case whether to register in the first transmission network (N1) and for initiating registration or logging off, a terminal (T1) with an interface to a first transmission network (N1) and an interface to a second transmission network (N2), characterised in that the terminal (T1) is suitable for initiating registration in the first transmission network (N1), terminal (T1) is suitable for receiving signals from a second terminal (T2) via the second transmission network (N2), evaluating them and on identifying the second terminal (T2) as a terminal with higher priority deciding independently whether to log off from the first transmission network (N1) and initiating this if the decision is positive, and a terminal (T2) with an interface to a first transmission network (N1) and an interface to a second transmission network (N2), characterised in that terminal (T2) is suitable for receiving signals from a second terminal (T1) via the second transmission network (N2), evaluating them and on identification of the second terminal (T1) as a registered terminal with a lower priority deciding independently whether to register in the first transmission network (N1) and initiating this if the decision is positive.

By automatic, direct point-to-point communication, e.g. by means of Bluetooth, without involving a central server two terminals establish which of the terminals should preferably communicate with a transmission network and register only one of the two terminals in the transmission network. The terminals are mutually identifed for this purpose as terminals belonging to a pool of terminals of a subscriber and, as well as the list of terminals of the pool, also have, for example, an order of precedence stored. The order of precedence is similar to an allocation of priorities. If two terminals are located in a Bluetooth network they are mutually identified. If one terminal establishes that the priority assigned to the other terminal is lower than its own it logs on in a transmission network assigned to it by registering or remains registered in so far as it already was registered. If a terminal establishes that the priority assigned to the other terminal is higher than its own it logs off in a transmission network assigned to it in so far as it was logged on by registering. The transmission networks of the two terminals can be identical or different. In the switching over process of registering one and de-registering the other terminal the same registration number or different registration numbers can be used. It has an advantageous effect if always the same registration number is used, for example in a UMTS mobile telephone carried by a subscriber, and the UMTS car telephone of the subscriber is automatically activated during a car journey and registered in the UMTS network with the same registration number as the UMTS mobile telephone, which is logged off from the UMTS network during the car journey. However, features, subscriber profiles, databases, etc. of the UMTS mobile telephone can be made available on the UMTS car telephone via a Bluetooth connection between UMTS mobile telephone and UMTS car telephone.

### BEST MODE FOR CARRYING OUT THE INVENTION

An embodiment example of the invention is explained below with the aid of a figure.

The figure shows a schematic illustration of a transmission system according to the invention.

The transmission system contains a first transmission network N1, a second transmission network N2, a first terminal T1 and a second terminal T2.

The first transmission network N1 is executed, for example, as a so-called core network, as a radio network, GSM, UMTS, GSM and UMTS, PMR, etc.

The second transmission network N2 is executed, for example, as a Bluetooth network, HiperLan2, wireless LAN 8002.11, wireless LAN 8002.11, infrared network, ultrasound network or some other transmission medium.

The first terminal T1 is executed, for example, as a cordless telephone, mobile cordless telephone, GSM mobile telephone, UMTS mobile telephone, etc.

The second terminal T2 is executed, for example, as a cordless telephone, mobile cordless telephone, GSM mobile telephone, UMTS mobile telephone, car telephone, cable-based terminal, etc.

Both terminals T1, T2 belong, for example, to a subscriber. The subscriber, with his terminal T1, executed as a GSM mobile telephone, enters his car, in which his terminal T2, executed as a GSM car telephone, is installed. Terminal T1 is registered in transmission network N1, which is executed, for example, as a GSM network. Terminal T2 has not yet been registered. Via transmission network N2, executed, for example, as a Bluetooth, the two terminals identify one another. Identification takes place automatically when both terminals T1, T2 come into the Bluetooth range and, e.g. by a terminal or identification number of terminal T2, stored in terminal T1, and by a terminal or identification number of terminal T1, stored in terminal T2. By means of pre-setting in both terminals T1, T2, terminal T2 is now automatically registered in transmission network N1 instead of terminal T1, whereby following calls are always forwarded to terminal T2. Without any action on the part of the subscriber terminal T2 is now registered, giving the subscriber the advantage of higher speech quality of the car telephone, use of the hands-free system of the car telephone, etc. during car travel, without the subscriber having actively and laboriously to initiate this. This new service makes the use of mobile cordless telephones more convenient. When the subscriber leaves the car it is recognised that the Bluetooth connection between the terminals T1, T2 has been interrupted, resulting in terminal T2 being automatically logged off and terminal T1 being newly registered, whereby subsequently all calls are again automatically forwarded to terminal T1. This too happens without any action on the part of the subscriber, so here too maximum convenience can be provided for the subscriber.

Transmission network N1 can also consist of two or more instead of one network, for example of a GSM network and a cable-based intermediary network. The subscriber has, for example, a terminal T1 executed as a GSM mobile telephone and a terminal T2 executed as DECT telephone or DECT base station. Both terminals have a Bluetooth aerial for the purpose of enabling internal communication via transmission network N2. The DECT telephone is in the subscriber's house. If the subscriber is outside the house and outside the range of Bluetooth, his terminal T1 is activated, i.e. he is registered in the GSM network. If the subscriber is inside the house terminals T1 and T2 communicate automatically with one another via Bluetooth, identify one another and a switchover is initiated. Terminal T2 is registered in the cable-based intermediary network via the DECT base station, in so far as it has not already been registered, and terminal T1 is logged off. All new calls are then automatically forwarded to the DECT telephone. The subscriber has the advantage of better speech quality of the DECT telephone and lower fees. If the subscriber leaves the house with his GSM mobile telephone, this is re-registered. The DECT telephone optionally remains registered or is logged off. The DECT telephone can, for example, be appropriately programmed. With a single person it is preferably logged off and with a family preferably continues to be registered so that the other family members in the house can continue to use the telephone.

Equally demonstrable are examples with two UMTS terminals, one GSM terminal and one UMTS terminal, one UMTS terminal, one UMTS car telephone and one DECT terminal.

The important thing is the possibility of internal communication between the terminals and the possibility of identifying the other terminal(s).

In one configuration of the invention the subscriber profile can be made available in each case on the current terminal. The subscriber profile is, for example, stored on a SIM card of the subscriber. The SIM card is, e.g., inserted into terminal T1. After registration of terminal T2, terminal T2 has, for example, access to the data stored on the SIM card and in this way to the subscriber profile, containing, for example, a telephone list, an appointments diary, etc. Access can take place, e.g. by copying the data and transmitting it via Bluetooth to terminal T2. Transmission takes place, for example, in code. Or access takes place in that the data which are to be accessed are represented only on terminal T2, i.e. are mirrored, but operation, selection, etc. still continue to be carried out on terminal T1. Terminal T2 contains, for example, no SIM card, i.e. every operation continues to be carried out by terminal T1 with the aid of Bluetooth or a SIM card, e.g. a twin SIM card, and all or parts of the operations are carried out by terminal T2 itself. The download of data from the SIM card of terminal T1 on to the SIM card of terminal T2 is deleted after deactivation of terminal T2, to prevent unauthorised access. Instead of Bluetooth, for example, infrared, ultrasound or other transmission media can be used.

The terminals can be programmed in such a way that the new service of priority-related registering and logging off according to the invention can be switched off and switched on. The subscriber can then choose whether he wishes to avail himself of this service or not. If a subscriber wishes always to avail himself of this service, he will programme his terminals or a selection of them in such a way that they have the service permanently switched to active and thus a switchover to the terminal with the higher priority takes place automatically as soon as two terminals come into the range of the second transmission network. The terminals can further be programmed in such a way that it is not possible to log off from a transmission network while a telephone call is in progress. This is intended to prevent, for example, a subscriber who is speaking on the telephone and approaching his car having to accept an interruption of his connection or a switchover to his car telephone taking place, even though the subscriber is not yet in the car.

1. Method of selecting one of at least two terminals, wherein each terminal has an interface to a first and a second transmission network and the second transmission network enables a direct connection between two terminals within a circumscribed area, wherein two terminals identify one another via the second transmission network and decide independently whether to register in the first transmission network and initiate registration or logging off.

2. Method according to claim 1, wherein the first transmission network contains one or two networks, the first transmission network has a GSM network, UMTS network, DECT network and/or cable-based intermediary network, the second transmission network has a Bluetooth network, one terminal is executed as a GSM terminal with Bluetooth interface, a UMTS terminal with Bluetooth interface, a DECT terminal with Bluetooth interface or a cable-based terminal with Bluetooth interface and another terminal is executed as a GSM terminal with Bluetooth interface, a UMTS terminal with Bluetooth interface, a DECT terminal with Bluetooth interface or a cable-based terminal with Bluetooth interface.

3. Transmission system containing a first transmission network, a second transmission network, a first terminal with an interface to the first and an interface to the second transmission network and a second terminal with an interface to the first and an interface to the second transmission network, wherein the two terminals are suitable for identifying one another via the second transmission network and for deciding independently in each case whether to register in the first transmission network and for initiating registration or logging off.

4. Terminal with an interface to a first transmission network and an interface to a second transmission network, wherein the terminal is suitable for initiating registration in the first transmission network, terminal is suitable for receiving signals from a second terminal via the second transmission network, evaluating them and on identifying the second terminal as a terminal with higher priority deciding independently whether to log off from the first transmission network and initiating this if the decision is positive.

5. Terminal with an interface to a first transmission network and an interface to a second transmission network, wherein terminal is suitable for receiving signals from a second terminal via the second transmission network, evaluating them and on identification of the second terminal as a registered terminal with a lower priority deciding independently whether to register in the first transmission network and initiating this if the decision is positive.

6. Terminal according to claim 5, wherein terminal is suitable for requesting from the second terminal the registration number under which the second terminal is registered in the first transmission network, or has a memory in which the registration number is stored, and for logging itself on in the first transmission network under this registration number.
